(19) United States
(12) Patent Application Publication
(10) Pub. No.: US 2010/0147955 A1
(43) Pub. Date: Jun. 17, 2010

(54) Rapid focusing during aiming in laser scanner

(76) Inventors: Paul Dvorkis, East Setauket, NY (US); Edward Barkan, Miller Place, NY (US); Mark Drzymala, Commack, NY (US)

Correspondence Address: MOTOROLA, INC., 1303 EAST ALGONQUIN ROAD, IL01/3RD, SCHAUMBURG, IL, 60196, US

(21) Appl. No.: 12/316,844

(22) Filed: Dec. 17, 2008

(51) Int. Cl. G06K 7/10

(52) U.S. Cl. 235/470

(57) ABSTRACT

A laser scanner includes a laser, a variable focusing element, a scanner, a detector, and a controller that controls the scanner to sweep a laser beam over an aiming angle at an aiming rate to form an aiming line on a symbol during aiming, and over a reading angle at a reading rate to form a reading line on the symbol during reading that follows the aiming. The aiming angle is smaller than the reading angle. The aiming rate is higher than the reading rate. The aiming line is shorter than the reading line. The controller determines a depth of modulation of an analog signal generated during aiming, and controls the variable focusing element to focus the laser beam on the symbol during aiming when the depth of modulation is determined to be optimum. The controller also processes the analog signal to data indicative of the symbol during reading.

### DESCRIPTION OF THE RELATED ART

Moving laser beam readers or laser scanners have been used, in both handheld and hands-free modes of operation, in supermarkets, warehouse clubs, department stores, and other kinds of retailers for many years, to electro-optically read one-dimensional bar code symbols, particularly of the Universal Product Code (UPC) type, each having a row of bar elements and space elements spaced apart along one direction. A laser beam reader generally includes a laser for emitting a laser beam, a focusing lens assembly for focusing the laser beam to form a beam spot having a certain spot size at a predetermined working distance or focal plane, a scan component for repetitively sweeping the beam spot over a scan angle across a target symbol in a scan pattern, for example, a scan line or a series of scan lines across the target symbol, a photodetector for detecting light reflected and/or scattered from the symbol and for converting the detected light into an analog electrical signal, and signal processing circuitry including a digitizer for digitizing the analog signal, and a microprocessor for decoding the digitized signal into data indicative of the symbol based upon a specific symbology used for the symbol.

It is desirable that the symbol be capable of being scanned over an extended range of working distances relative to the reader. For this purpose, it is conventional to move one or more variable focusing lenses in the focusing lens assembly and, in turn, to move the focal plane of the laser beam between close-in and far-out working distances relative to the reader in the range until the focal plane is in the vicinity of the symbol. This lens movement is typically performed mechanically, and often under the guidance of a rangefinder operative for measuring the distance of the symbol away from the reader. However, this is disadvantageous for several reasons. First, the mechanical movement generates vibrations that are propagated through the reader to an operator's hand in a handheld mode of operation, and may also generate dust to obscure the lens assembly, and may cause parts to wear out over time. Moreover, the vibrations can generate objectionable, annoying, audible hum. In addition, the mechanical lens movement requires a drive that, in turn, consumes electrical power, is expensive and slow, can be unreliable, occupies space and increases the overall weight, size and complexity of the reader. Also, the rangefinder itself represents added expense, size and complexity.

To avoid such mechanical movement, a variable focus liquid lens based on an electro-wetting effect has been proposed in U.S. Pat. No. 7,201,318 and No. 7,264,162 for use in laser beam readers, in which an electrical voltage is applied to the liquid lens to change an optical power or property, e.g., a focal length, thereof. It has further been proposed, for example, in U.S. Pat. No. 4,190,330, No. 5,305,731, and No. 6,859,333 to achieve variable focusing using liquid crystal (LC) materials and liquid cells of the type used in optical displays.

Although the known variable focusing assemblies are generally satisfactory for their intended purpose, one concern relates to when and how rapidly the focusing assemblies can be adjusted to focus the laser beam on symbols located at various different distances from the reader. If the focusing adjustment takes too long, e.g., on the order of 200 milliseconds, then the reader will be regarded as sluggish, which operators do not like. A more responsive reader, e.g., one having reading times on the order of 50 milliseconds or less, is desired for enhanced operator use and reading performance.

### SUMMARY OF THE INVENTION

One feature of this invention resides, briefly stated, in an electro-optical reader for, and a method of, reading a symbol, such as one- and/or two-dimensional bar code symbols. The reader includes a light source, such as a laser, for emitting a laser beam along a path, and an optical assembly that includes a variable focusing element for focusing the light beam on the symbol located in a range of working distances relative to the reader along the path. The optical assembly preferably also includes a fixed focusing lens and a focusing aperture together operative for generally collimating the laser beam. The reader further includes a scanner for sweeping the light beam across the symbol for return therefrom, and a detector for detecting return light from the symbol, and for generating an electrical analog signal indicative of the detected return light.

A controller is operative for controlling the scanner to sweep the light beam over an aiming angle at an aiming rate to form an aiming line on the symbol during an aiming mode of operation, and over a reading angle at a reading rate to form a reading line on the symbol during a reading mode of operation that follows the aiming mode. The aiming angle is smaller than the reading angle. The aiming rate is higher than the reading rate. The aiming line is shorter than the reading line.

The controller is further operative for determining a depth of modulation of the analog signal during the aiming mode, and for controlling the variable focusing element to focus the light beam on the symbol during the aiming mode when the depth of modulation is determined to be optimum. The scanner repetitively generates a plurality of aiming lines during the aiming mode, and the controller determines the depth of modulation of the analog signal for each aiming line during the aiming mode, and determines that the depth of modulation is optimum when the depth of modulation is at a maximum. The variable focusing element is driven at resonance during the reading mode, and is driven above resonance during the aiming mode. The controller is still further operative for processing the analog signal to data indicative of the symbol during the reading mode.

In one embodiment, the variable focusing element is a variable liquid crystal (LC) lens having a changeable optical index of refraction, and the controller is operative for changing the index of refraction of the LC lens in the aiming mode. In another embodiment, the variable focusing element is an electro-wetting liquid lens having a liquid with a changeable curvature, and the controller is operative for changing the curvature of the liquid in the aiming mode.

Advantageously, the focusing adjustment is performed rapidly, on the order of 50 milliseconds or less, due to the smaller aiming angle, the higher aiming rate, the shorter aiming line and the repetitive generation of the aiming lines, all of which enable the controller to more quickly determine the maximum depth of modulation during the aiming mode and to control the variable focusing element to focus the light beam on the symbol. Once focusing is complete, the controller decodes the symbol during the subsequent reading mode, and the reading performance is responsive.

The method of reading a symbol is performed by emitting a light beam along a path; focusing the light beam on the symbol located in a range of working distances along the path with a variable focusing element; sweeping the light beam across the symbol for return therefrom; detecting return light from the symbol, and generating an electrical analog signal indicative of the detected return light; and controlling the sweeping step to sweep the light beam over an aiming angle at an aiming rate to form an aiming line on the symbol during an aiming mode of operation, and over a reading angle at a reading rate to form a reading line on the symbol during a reading mode of operation that follows the aiming mode. The aiming angle is smaller than the reading angle. The aiming rate is higher than the reading rate. The aiming line is shorter than the reading line. The controlling step includes determining a depth of modulation of the analog signal during the aiming mode, and controlling the variable focusing element to focus the light beam on the symbol during the aiming mode when the depth of modulation is determined to be optimum, and processing the analog signal to data indicative of the symbol during the reading mode.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic diagram of a handheld moving laser beam reader for reading a bar code symbol;

FIG. 2 is an enlarged, sectional view of a variable liquid lens of the electro-wetting type used in the reader of FIG. 1;

FIG. 3 is a diagrammatic view of a variable liquid crystal (LC) lens used in the reader of FIG. 1;

FIG. 4 is a diagrammatic view of an arrangement according to this invention using the LC lens in the reader of FIG. 1;

FIG. 5 is a waveform of an electrical analog signal generated in the reader of FIG. 1;

FIG. 6 is a view of a symbol overlaid by an aiming line during an aiming mode of operation of the reader of FIG. 1; and

FIG. 7 is a view of the symbol of FIG. 6 overlaid by a reading line during a reading mode of operation of the reader of FIG. 1.

### DETAILED DESCRIPTION OF THE PREFERRED EMBODIMENTS

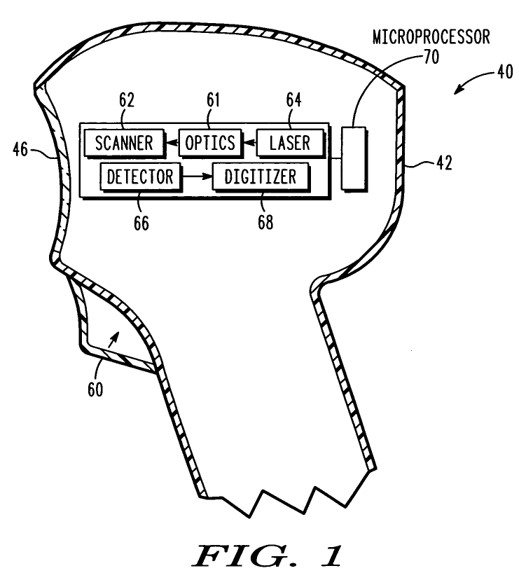

FIG. 1 depicts a conventional moving laser beam reader 40 for electro-optically reading indicia, such as a symbol, during a reading mode that may use, and benefit from, the present invention. The beam reader 40 includes a scanner 62 in a housing 42 for scanning an outgoing laser beam from a laser 64 and/or a field of view of a light detector or photodiode 66 in a scan pattern, typically comprised of one or more scan lines, through a window 46 across the symbol for reflection or scattering therefrom as return light detected by the photodiode 66 during reading. The beam reader 40 also includes a focusing lens assembly or optics 61 for optically modifying the outgoing laser beam to have a large depth of field or range of working distances, and a digitizer 68 for converting an electrical analog signal generated by the detector 66 from the return light into a digital signal for subsequent decoding by a microprocessor or controller 70 into data indicative of the symbol being read.

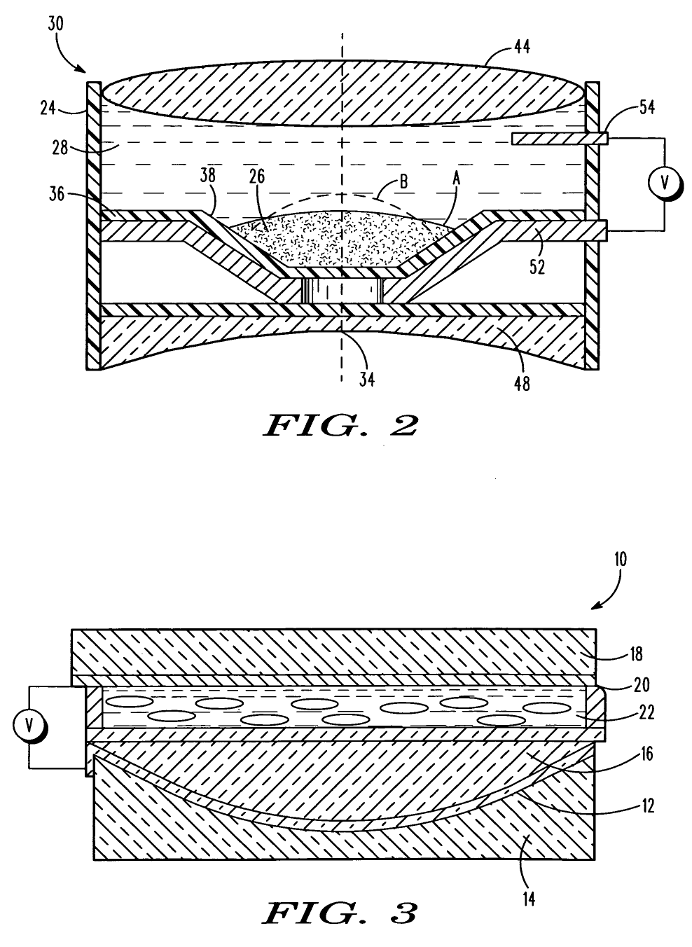

The focusing lens assembly 61 includes a variable focusing element for extending the range of working distances relative to the reader. The variable focusing element may be a liquid lens of the electro-wetting type 30 as shown in FIG. 2, or of the liquid crystal type 10 as shown in FIG. 3.

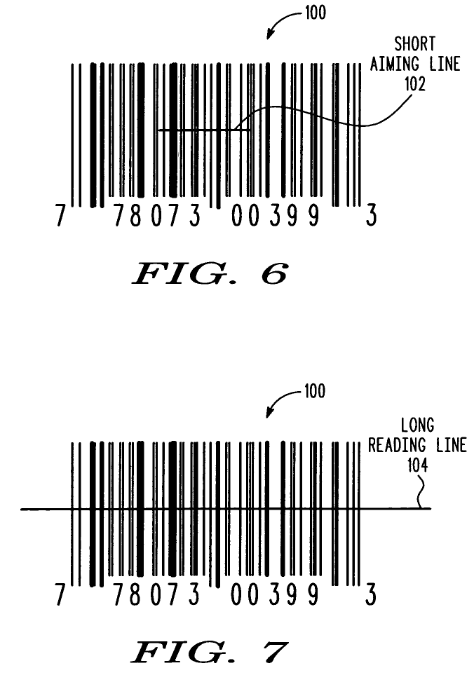

The electro-wetting liquid lens 30 of FIG. 2 has a housing 24 in which a first liquid 26, shown in droplet form, and a second liquid 28 are arranged along an optical path 34 that extends toward an indicia such as the symbol 100 (see FIGS. 6-7) to be read. The liquids 26, 28 are light-transmissive, immiscible, of different optical indices of refraction, and of a substantially same density. The liquid or drop 26 is constituted of an electrically insulating substance. For example, an oil, an alcane, or a blend of alcanes, preferably halogenated, or any other insulating liquid may be used for the drop 26. The liquid 28 is constituted of an electrically conductive substance, for example, water loaded with salts (mineral or other), or any other liquid, organic or not, and preferably made conductive by the addition of ionic components.

The housing 24 is constituted of an electrically insulating, light-transmissive, material, such as glass, preferably treated with silane or coated with a fluorinated polymer, or a laminate of fluorinated polymer, epoxy resin and polyethylene. The housing 24 includes a dielectric wall 36, preferably having a well 38 in which the drop 26 is accommodated in symmetrical relation relative to the optical path or axis 34. The wall 36 normally has a low wetting characteristic compared to the drop 26, but a surface treatment insures a high wetting characteristic and maintains a centered position of the drop 26 and prevents the drop from spreading. The well 38 further helps to prevent such spreading.

A first electrode 54 extends into the liquid 28, and a second electrode 52 is located below the wall 36. The electrodes are connected to a voltage source V. The electrodes, especially electrode 52, are preferably light-transmissive. When a voltage is applied across the electrodes, an electrical field is created which alters the wetting characteristic of the wall 36 with respect to the drop 26. The wetting increases substantially in the presence of an electrical field. With no voltage applied, the drop 26 takes the generally hemispherical shape in a rest state shown in solid lines in FIG. 2, and its outer surface “A” is convex. When a voltage is applied, the wetting of the dielectric wall 36 increases, and the drop 26 deforms and takes the shape shown in dashed lines in FIG. 2, and its outer surface “B” is more convex with a smaller radius of curvature. This deformation of the drop changes the focus of the lens 30 and is employed to adjust the focal length of the focusing lens assembly 61 to focus the laser beam on the target symbol 100 over a range of working distances.

By way of example, the drop 26 in the rest state has a diameter of about 6 mm. If the liquid 28 is salt water, its index of refraction is about 1.35. If the drop 26 is oil, its index of refraction is about 1.45. About 40 diopters of focus variation can be achieved for an applied voltage of about 40 v RMS. The response time of the liquid lens is several hundredths of a second, in which case, if a periodic voltage is used, the frequency can be between 50 Hz and 10 kHz so that its period is smaller than the response time.

The liquid lens 30 may also have a fixed convex lens 44 at one axial end region, and a fixed concave, or plano-concave, lens 48 at the opposite axial end region. These fixed lenses may be part of the overall focusing lens assembly 61 and assist in minimizing any kind of aberrations, for example, chromatic aberrations.

As described so far, the change in curvature of the drop 26 is between two convex curvatures A, B. It is also within the spirit of this invention to deform the drop 26 between different curvatures. For example, it is possible that the outer surface of the drop could be a meniscus, that is concave in the rest state, generally flat to focus the light at a first focal plane when a first voltage is applied, and convex to focus the light at a second focal plane when a second, different voltage is applied.

The variable liquid crystal (LC) lens 10 of FIG. 3 has a first, glass or polymer, substrate 13 having a lower portion 14 with a concave surface, an upper portion 16 with a convex surface of complementary contour to the concave surface, and a curved, optically transparent, electrically conductive, electrode 12 made from a material such as indium-tin-oxide between the upper and lower portions of the substrate 13. The LC lens 10 also has a second, glass or polymer, generally planar substrate 18 having a surface coated with a generally planar, optically transparent, electrically conductive, electrode 20. The two substrates 13 and 18 face an LC layer or cell 22, and are coated with alignment layers (not shown). Alignment layers are used on the opposing surfaces of the substrates adjacent to the LC layer to produce a homogeneous alignment. Persons skilled in the art may select from a wide variety of materials, usually polyimides, including, but not limited to, polyvinyl alcohol (PVA) for use as alignment layers on the substrates. The LC layer is injected into the cell.

The LC layer 22 has at least one semi-ordered, mesomorphic or nematic phase, in addition to a solid phase and an isotropic liquid phase. Molecules of the nematic LC layer typically are rod-shaped with the average direction of the long axes of the rod-shaped molecules being designated as the director, or may be disk-shaped with the direction perpendicular to the disk-shaped molecules being designated as the director. The nematic phase is characterized in that the directors are aligned in a preferred direction.

Birefringence in nematic LC materials is most readily described in terms of a splitting of incoming light entering the LC layer into two perpendicularly polarized rays called the ordinary ray and the extraordinary ray. A variation in a refractive index of the LC layer 22 with respect to the extraordinary ray is effected by varying the angle between the directors relative to the direction of the incoming light. Such tilting of the directors in the LC layer is produced by varying the strength of an electric or magnetic field across the LC layer 22. The directors typically tend to align themselves generally parallel to the direction of the electric or magnetic field. There is a threshold field strength below which the directors do not appreciably respond to the applied field and above which they respond monotonically as the field strength increases until realignment in response to the field reaches saturation.

The refractive index of the LC layer 22 changes in response to a change of field strength to produce a variation of optical properties, e.g., focal length, in the focusing lens assembly 61 in the reader 40. When a voltage V is applied across the electrodes 12, 20, the electric field will produce a centro-symmetrical gradient distribution of refractive index within the LC layer 22. The LC layer 22 causes light to be modified, e.g., focused, when a suitable voltage is applied across the electrodes.

The voltage for either liquid lens 10, 30 is preferably periodic, preferably a square wave drive voltage. The square wave is easily created with a variable duty cycle by the microprocessor or controller 70 having a built-in pulse width modulator circuit. The drive voltage could also be sinusoidal or a triangular wave signal, in which case, the amplitude of the voltage controls the shape of the drop 26 or the refractive index of the LC layer 22 and, in turn, the focal length and the working distance. When a square wave is used, focal length changes are achieved by varying the duty cycle. When a sinusoidal wave is used, focal length changes are obtained by varying the drive voltage amplitude. The amplitude or the duty cycle can be changed in discrete steps (digital manner) or continuously (analog manner) by the microprocessor or controller 70. The voltage could also be a constant DC voltage.

As described in detail below, the controller 70 operates to apply the voltage to either liquid lens 10, 30 during an aiming mode prior to the reading mode. The aiming mode can be initiated by actuation of a trigger 60 on the reader 40.

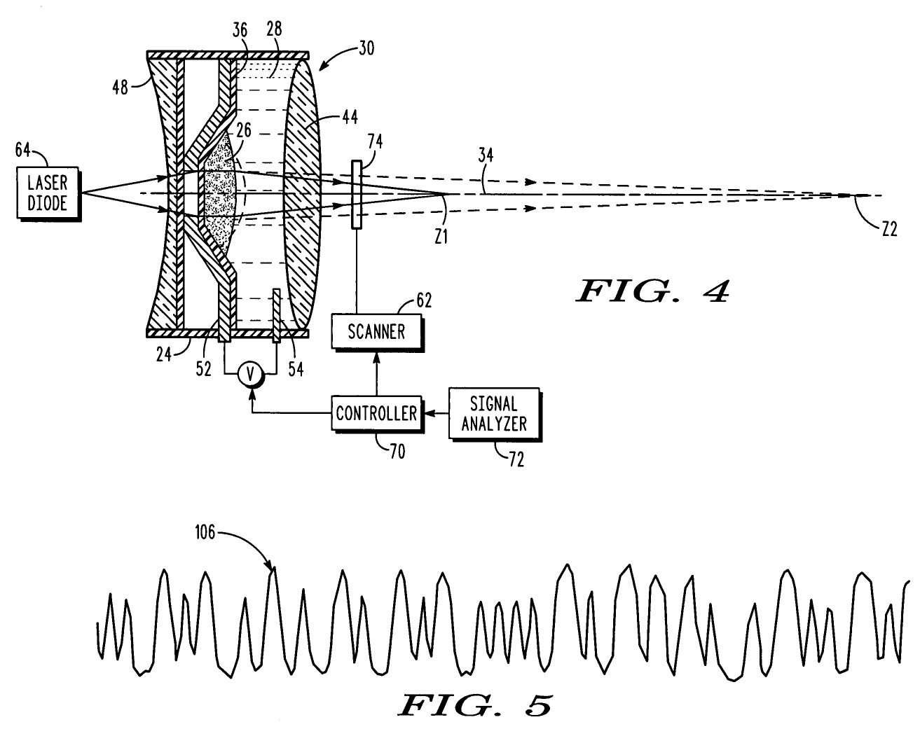

Turning now to FIG. 4, the light source 64 of FIG. 1 is shown as a laser diode operative for emitting a laser beam along the optical path 34. The change in voltage in either liquid lens 10, 30, under the control of the controller 70, is responsible for varying the focal point location between a close-in position or plane Z1 and a far-out position or plane Z2 arranged along the optical path 34. The symbol 100 can be read at, and anywhere between, these end-limiting positions, thereby improving the working range of the moving beam reader 40.

The reader 40 further includes the scanner 62 for repetitively sweeping the laser beam across the symbol 100 for return therefrom. The scanner 62 typically oscillates a scan mirror 74 at a scan angle and at a scan rate, e.g., fifty scans per second. The detector 66 detects return light from the symbol 100, and generates an electrical analog signal 106, as depicted in FIG. 5, indicative of the detected return light. A signal analyzer 72 analyzes the analog signal 106, as described below.

The controller 70 is operative for controlling the scanner 62 to sweep the laser beam over an aiming angle at an aiming rate to form an aiming line 102 (see FIG. 6) on the symbol 100 during the aiming mode of operation, and over a reading angle at a reading rate to form a reading line 104 on the symbol 100 during the reading mode of operation that follows the aiming mode. The aiming angle is smaller than the reading angle. The aiming rate is higher than the reading rate. The aiming line 102 is shorter than the reading line 104.

The controller 70 is further operative for determining a depth of modulation of the analog signal 106 during the aiming mode, and for controlling the variable focusing element 10, 30 to focus the laser beam on the symbol 100 during the aiming mode when the depth of modulation is determined to be optimum. The scanner 62 repetitively generates a plurality of aiming lines 102 during the aiming mode, and the controller 70, with the aid of the signal analyzer 72, determines the depth of modulation of the analog signal for each aiming line 102 during the aiming mode, and determines that the depth of modulation is optimum when the depth of modulation is at a maximum. The variable focusing element 10, 30 is driven at resonance during the reading mode, and is driven above resonance during the aiming mode. The controller 70 is still further operative for processing the analog signal 106 to data indicative of the symbol during the reading mode.

The voltage waveform of the analog signal of FIG. 5 increases when the laser beam is sweeping a space element, or “white part” of the symbol 100, and decreases when the laser beam is sweeping a bar element, or “black part” of the symbol 100. The widths of the high areas (peaks) and low areas (valleys) of the waveform are proportional to the widths of the bar elements and the space elements being swept. When the laser beam is focused such that the laser beam diameter, i.e., the laser spot, at the symbol 100 is similar to, or smaller than, the narrow bar elements or space elements in the symbol 100, then the voltage amplitudes of the peaks (or valleys) when scanning a narrow bar element (or space element) will be about equal to the voltage amplitude when scanning a wide bar element (or space element). If, on the other hand, the laser beam is focused such that the laser spot is wider than the narrow bar or space elements, but not wider than the wide bar or space elements, then the voltage amplitude of the peaks (or valleys) when scanning the narrow bar or space elements will be smaller than when scanning the wide bar or space elements.

It is, therefore, possible for the signal analyzer 72 to determine when the laser beam is focused to the smallest possible spot size by comparing how high the peaks and valleys of the wide bar or space elements are, when compared to the peaks and valleys of the narrow bar or space elements. If there is a large discrepancy, then the laser beam is not well focused, and, as a result, the controller 70 for the variable focusing lens 10, 30 will continue changing the drive voltage until such time that the narrow peaks (or valleys) and the wide peaks (or valleys) are most similar, which will be the point of optimum focus or maximum depth of modulation.

It should be noted that the reader 40 might never be able to make the wide and narrow peaks equal, because, even when the focus is best, the size of the laser spot may be wider than the narrow bar and space elements, and, hence, the digitizer 68 that is used is tolerant of this. Hence, as long as the wide and narrow peaks are close enough to be substantially equal, then the controller 70 will still be able to decode the symbol 100.

In practice, an analog-to-digital (A/D) converter is used to sample the waveform of the analog signal 106. The controller 70 is programmed to look through the sampled data from the A/D converter to locate the peaks and valleys. There will be some noise on the analog signal 106 that will make small peaks and valleys that are unrelated to the return light from the symbol 100. These small peaks and valleys due to noise must be ignored. There are several ways to do that. The analog signal 106 can be filtered prior to the A/D conversion to minimize noise, or the digitized signal can be passed through a digital filter to get the same result. In addition, peaks and valleys that are smaller than some predetermined amplitude can be ignored. This predetermined amplitude will be around the same as the minimum capability of the digitizer 68. For example, if the digitizer 68 cannot detect edges of bar elements or space elements that cause peaks on the signal of less than 1 volt, then the controller 70 will ignore peaks of less than 1 volt when searching for peaks and valleys that will be used to determine how well the laser beam is focused.

In accordance with an aspect of this invention, it is possible to determine when the laser scanner 40 is focused on the symbol 100 at any distance, by measuring the depth of modulation of the analog signal 106 as the symbol 100 is being swept during the aiming mode and the focus of the variable focusing element 10, 30 is being changed. When the depth of modulation is at a maximum, the focus is best. A separate rangefinder is not required.

The focusing process preferably proceeds as follows: The variable focusing element 10, 30 is initially set to focus at a starting point, probably the near or far end of the working distance range. The focus would then be slowly adjusted towards the other end of its range while the depth of modulation is being measured for each scan during aiming. At some point, the depth of modulation will be good enough to enable the symbol to be decoded, or if a decode does not occur (perhaps because the symbol is of poor quality and requires more than one attempt to decode), then the reader would continue changing the focus until it was determined that the depth of modulation is decreasing, thereby indicating that the focusing has passed the point of best focus. The reader can then return the focus to the position where the best depth of modulation was detected and hold it there until the decode occurs.

Several scans are typically required to achieve good focus, since the focusing cannot be adjusted too fast or the point of best focus might be passed between successive scans. If the scanner 62 runs at, for example, fifty scans per second, then each scan is 20 ms in duration. If it takes ten scans to achieve the optimum focus, then 200 ms will have elapsed before the controller 70 can decode the symbol, thereby making the reader 40 feel very slow. Decode times should be close to 50 ms or less if possible to make the reader feel very responsive to the operator.

Sometimes, there might be some target other than the symbol 100 that is being swept by the laser beam, and the reader might focus on that, instead of the symbol 100. If that other target is at a different distance than the symbol 100, then the focus necessary to read the symbol 100 might never be achieved. The present invention not only speeds up the time needed to achieve focus, but it also avoids the problem of having the reader focus on the wrong target.

Thus, when the trigger 60 is initially pressed, the reader 40 goes into the aiming mode in which the scanner 62 scans at a higher scan frequency as compared to the scan frequency during normal reading, but at a much narrower scan angle. The narrower scan angle makes the short aiming line 102 brighter, thereby facilitating aiming at symbols that are far away (e.g., more than fifty feet away from the reader). The short aiming line 102 generated in this aiming mode also minimizes the chances of the reader focusing on the wrong target, since the short aiming line 102 will not extend very much beyond the symbol. Also, the operator will normally center the symbol in the short aiming line 102.

Hence, the reader will measure the depth of modulation near the center of the short aiming line 102 and ignore whatever might be swept by the ends of the short aiming line 102. Since the scan frequency will be increased, e.g., by several times the reading frequency, when in this aiming mode, even though it will still require several scans to achieve a good focus, each scan is faster, and, as a result, the total elapsed time is much reduced. Once the optimum focus has been achieved, the scanner 62 can automatically increase its scan angle to the normal reading angle, and drop its aiming scan frequency to the normal reading scan frequency. As soon as this happens, the controller will rapidly decode the symbol, since it is already optimally focused.

Sometimes, the short aiming line 102 is long enough to entirely cover the symbol at a far-away distance. If so, then the reader can decode the symbol while still in the high frequency, narrow scan angle, aiming mode with no need to wait until the scan angle opens up and the scan rate drops. Also, an automatic gain control in the signal processing circuitry can be adjusted while in the aiming mode so that there will be no need to wait for the gain to be adjusted after the scanner 62 opens to a full scan angle.

The liquid lens 30 is especially desirable, because it can rapidly change amplitude, due to its low Q. It can be run at resonance in the full scan angle reading mode, but can also be driven above resonance in the aiming mode.

It will be understood that each of the elements described above, or two or more together, also may find a useful application in other types of constructions differing from the types described above. For example, the LC lens 10 can replace the liquid lens 30 in FIG. 4.

While the invention has been illustrated and described as embodied in a rapid focusing during aiming in electro-optical readers, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An electro-optical reader for reading a symbol, comprising:
a light source for emitting a light beam along a path;
an optical assembly including a variable focusing element for focusing the light beam on the symbol located in a range of working distances relative to the reader along the path;
a scanner for sweeping the light beam across the symbol for return therefrom;
a detector for detecting return light from the symbol, and for generating an electrical analog signal indicative of the detected return light; and
a controller operative for controlling the scanner to sweep the light beam over an aiming angle at an aiming rate to form an aiming line on the symbol during an aiming mode of operation, and over a reading angle at a reading rate to form a reading line on the symbol during a reading mode of operation that follows the aiming mode, the aiming angle being smaller than the reading angle, the aiming rate being higher than the reading rate, the aiming line being shorter than the reading line,
the controller being further operative for determining a depth of modulation of the analog signal during the aiming mode, and for controlling the variable focusing element to focus the light beam on the symbol during the aiming mode when the depth of modulation is determined to be optimum, and
the controller being further operative for processing the analog signal to data indicative of the symbol during the reading mode.

2. The reader of claim 1, wherein the light source is a laser for emitting the light beam as a laser beam; and wherein the variable focusing element is a variable liquid crystal (LC) lens having a changeable optical index of refraction; and wherein the controller is operative for changing the index of refraction of the LC lens in the aiming mode.

3. The reader of claim 1, wherein the light source is a laser for emitting the light beam as a laser beam; and wherein the variable focusing element is an electro-wetting liquid lens having a liquid with a changeable curvature; and wherein the controller is operative for changing the curvature of the liquid in the aiming mode.

4. The reader of claim 1, wherein the variable focusing element is driven at resonance during the reading mode, and is driven above resonance during the aiming mode.

5. The reader of claim 1, wherein the scanner repetitively generates a plurality of aiming lines during the aiming mode, and wherein the controller is operative for determining the depth of modulation of the analog signal for each aiming line during the aiming mode, and for determining that the depth of modulation is optimum when the depth of modulation is at a maximum.

6. An electro-optical reader for reading a symbol, comprising:
means for emitting a light beam along a path;
means including a variable focusing element for focusing the light beam on the symbol located in a range of working distances relative to the reader along the path;
means for sweeping the light beam across the symbol for return therefrom;
means for detecting return light from the symbol, and for generating an electrical analog signal indicative of the detected return light; and
control means for controlling the sweeping means to sweep the light beam over an aiming angle at an aiming rate to form an aiming line on the symbol during an aiming mode of operation, and over a reading angle at a reading rate to form a reading line on the symbol during a reading mode of operation that follows the aiming mode, the aiming angle being smaller than the reading angle, the aiming rate being higher than the reading rate, the aiming line being shorter than the reading line,
the control means being further operative for determining a depth of modulation of the analog signal during the aiming mode, and for controlling the variable focusing element to focus the light beam on the symbol during the aiming mode when the depth of modulation is determined to be optimum, and
the control means being further operative for processing the analog signal to data indicative of the symbol during the reading mode.

7. The reader of claim 1, wherein the emitting means is a laser for emitting the light beam as a laser beam; and wherein the variable focusing element is a variable liquid crystal (LC) lens having a changeable optical index of refraction; and wherein the control means is operative for changing the index of refraction of the LC lens in the aiming mode.

8. The reader of claim 1, wherein the emitting means is a laser for emitting the light beam as a laser beam; and wherein the variable focusing element is an electro-wetting liquid lens having a liquid with a changeable curvature; and wherein the control means is operative for changing the curvature of the liquid in the aiming mode.

9. The reader of claim 1, wherein the variable focusing element is driven at resonance during the reading mode, and is driven above resonance during the aiming mode.

10. The reader of claim 1, wherein the sweeping means repetitively generates a plurality of aiming lines during the aiming mode, and wherein the control means is operative for determining the depth of modulation of the analog signal for each aiming line during the aiming mode, and for determining that the depth of modulation is optimum when the depth of modulation is at a maximum.

11. A method of reading a symbol, comprising the steps of:
emitting a light beam along a path;
focusing the light beam on the symbol located in a range of working distances along the path with a variable focusing element;
sweeping the light beam across the symbol for return therefrom;
detecting return light from the symbol, and generating an electrical analog signal indicative of the detected return light; and
controlling the sweeping step to sweep the light beam over an aiming angle at an aiming rate to form an aiming line on the symbol during an aiming mode of operation, and over a reading angle at a reading rate to form a reading line on the symbol during a reading mode of operation that follows the aiming mode, the aiming angle being smaller than the reading angle, the aiming rate being higher than the reading rate, the aiming line being shorter than the reading line,
determining a depth of modulation of the analog signal during the aiming mode, and controlling the variable focusing element to focus the light beam on the symbol during the aiming mode when the depth of modulation is determined to be optimum, and
processing the analog signal to data indicative of the symbol during the reading mode.

12. The method of claim 11, wherein the emitting step is performed by emitting the light beam as a laser beam; and configuring the variable focusing element as a variable liquid crystal (LC) lens having a changeable optical index of refraction; and wherein the controlling step is performed by changing the index of refraction of the LC lens in the aiming mode.

13. The method of claim 11, wherein the emitting step is performed by emitting the light beam as a laser beam; and configuring the variable focusing element as an electro-wetting liquid lens having a liquid with a changeable curvature; and wherein the controlling step is performed by changing the curvature of the liquid in the aiming mode.

14. The method of claim 11, and driving the variable focusing element at resonance during the reading mode, and above resonance during the aiming mode.

15. The method of claim 11, wherein the sweeping step is performed by repetitively generating a plurality of aiming lines during the aiming mode, and wherein the wherein the controlling step is performed by determining the depth of modulation of the analog signal for each aiming line during the aiming mode, and determining that the depth of modulation is optimum when the depth of modulation is at a maximum.
